(19) United States
(12) Patent Application Publication
(10) Pub. No.: US 2008/0151725 A1
(43) Pub. Date: Jun. 26, 2008

(54) Apparatus And Method For Optimized Write Strategy Control

(75) Inventors: Ruud Vlutters, Eindhoven (NL); Alexander Padiy, Eindhoven (NL); Cornelis Marinus Schep, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/813,595

(22) PCT Filed: Jan. 5, 2006
(86) PCT No.: PCT/IB06/50048

§ 371 Date: Jul. 10, 2007

(30) Foreign Application Priority Data
Jan. 12, 2005 (EP) 05100134.5

(51) Int. Cl. G11B 5/09

(52) U.S. Cl. 369/59.11

(57) ABSTRACT

Apparatus and a method for optimizing one or more write parameters a write strategy in a recording process are disclosed. The optimization process may be conducted in a walking type optimization process, e.g. by running an optimization process every time a predetermined number of tracks has been recorded. The apparatus being capable of recording optical effects on a recordable medium and reading the recorded effects. The apparatus includes means for determining average transition shifts of leading and/or trailing edges in the read signal. At least one of the one or more write parameters in the write strategy is optimized in a feed-forward optimization process taking the average transition shifts into account. The invention also relates to an IC and to computer code for controlling an optical device.

The invention relates to an apparatus and a method for optimizing a write strategy in a recording process for recording information on an optical disc. The invention relates in particular to optimization of one or more write parameters in the write strategy.

The optimal amount of laser power needed for optical media recording depends inter alia on the specific medium, on the recording speed, and may even depend on the location on the medium. It is crucial that the correct power is supplied, since incorrect laser power settings may result in incorrect optical effects, such as too small or too large effects. Since the data to be recorded is represented by the pattern of these optical effects on the medium, this may result in incorrect recording of the information.

In current generation CD and DVD drives and next generation BD drives the laser power and write strategy to write data on a disk has to be controlled very precisely. This may currently be done in the following way. After an optimization (OPC, optimum power control) at the inner radius on jitter, the asymmetry is measured under the found optimal settings. After writing several tracks (for example about 100), the last track is read-back, and the asymmetry is measured. When the track appears to have a higher asymmetry than the found optimum, the writing power is reduced, and if the track has too little asymmetry, the write-power is increased. This method of semi-continuous adaptation of the write-power is called walking OPC, because only at specified steps (positions) is the write power modified.

Because only one parameter is currently measured (the asymmetry), also only one parameter can be adapted (the write power). In this way, only the variations in the required write power in a write-once stack from the inner to the outer diameter are taken into account. Not only the required power, but also the optimal write strategy can vary, due to variations in thickness of layers in the write-once stack (e.g. the dye, the mirror and the dielectric layers) and due to a different linear velocity (not constant in CAV mode). This is currently not taken into account in commercial available apparatuses (the write strategy is fixed by the optimization routine at start-up).

In the published US application 2004/0130993 a method and an apparatus for optimizing a high-speed write procedure is disclosed. Tables defining various dynamic write strategy scenarios may be accessed and thereby enabling dynamic adjustments to the laser power levels and/or pulse edges.

The ever-increasing demand for storage capacity and access speed necessitates the use of accurate and responsive control mechanisms. Therefore, there is a need in the art for improved optical apparatuses and improved ways of ensuring optimal optical recording.

The present invention seeks to provide such an improved optical apparatus with improved means for ensuring optimized recording during a recording process. Preferably, the invention alleviates or mitigates one or more of the above or other disadvantages, singly or in any combination.

Accordingly there is provided, in a first aspect, an optical recording apparatus with optimized write strategy control, the apparatus comprising:

a radiation source for emitting a radiation beam so as to record optical effects on a recordable medium, the radiation beam being emitted in accordance with a write strategy including one or more write parameters,

a read unit for reading the recorded effects so as to provide a read signal, the read signal comprising first sections reflected from first regions with first widths, and second sections reflected from second regions with second widths, wherein transitions from the first to the second regions are labeled leading edges and transitions from the second regions to the first regions are labeled trailing edges,

wherein average transition shifts of leading and/or trailing edges are determined in the read signal, and wherein at least one of the one or more write parameters in the write strategy is optimized in a feed-forward optimization process taking the average transition shifts into account.

The read signal may be a measured optical signal, such as a measured optical signal from a write-once or rewritable CD-type disk, DVD-type disk, BD-type disk etc. The read signal is a modulated signal wherein the modulation represents the binary data present on the disk. On the disk information is stored in a pattern of optical effects, e.g. referred to as marks. A typical encoding of the information is the runlength encoding, where information is stored in optical effects and spaces between the optical effects, as wells as the lengths of the optical effects and the spaces. The bit pattern on a disk may in the runlength encoding be represented by a timing sequence of transition shifts between spaces and optical effects.

The read signal thus comprises first and second sections corresponding to whether the light was reflected from first or second regions. The first and second regions may be identified as spaces and marks respectively in a phase-change type disk or write-one type disk. The transitions from the first to the second regions are labeled leading edges indexed by the first and second widths (also referred to as lengths) and transitions from the second regions to the first regions are labeled trailing edges indexed by the second and first widths (lengths). In a phase-change type disk, leading edges refer to transitions from high reflectivity regions to low reflectivity regions and trailing edges the other way around.

Optical effects are provided to an optical medium by driving the radiation source in accordance with a write strategy. In general the optical effects are written by means of laser pulses with a pulse shape characterized by a number of write parameters, this is referred to as a write strategy. Typically, the write strategy may be described by a number of write parameters such as commands to turn laser power on and off, setting the laser power to a specific level, maintaining the laser power for a given duration, etc.

The write strategy may depend upon the desired specific optical effect, i.e. the length of the effect and the write parameters in a write pulse for writing a specific optical effect. Standard write strategies may exist categorized according to the resulting length of the written optical effect, i.e. I2-strategies for writing I2-marks, I3-strategies for writing I3-marks, etc.

Because a disk is not perfectly homogeneous, the system is heating up etc., it may be important, and sometimes even necessary, to calibrate, i.e. optimize, the write strategy before and during the recording of data on an optical recordable medium.

In current systems where only the asymmetry is measured only the write power can be adapted, because only one parameter is measured. However, by determining the average transition shifts of leading and/or trailing edges in the read signal a number of optimization parameters is provided and consequently more than one write parameters may be optimized in the write strategy. It is an advantage to be able to adapt more than one parameter in the write strategy, since a more detailed and more complete optimization may be performed. One may e.g. be able to do a 1-step optimization of a write strategy, or even of all write strategies, e.g. the I2 to I9 strategies.

The optimization process may be a feed-forward optimization process which on the basis of the average transition shifts optimize one or more write parameter. In case a write parameter is already optimized, the write parameter is maintained, the optimization process in this situation is thus the means for determining whether the write parameter is optimal or not.

The present invention even renders it possible to optimize a recording process on storage media for such data capacities as capacities above 30 GB, such as in the range 30-37 GB, since the average transition shifts may be provided for such data densities. This is an advantage since currently no alternative method exists for optimizing the recording process on such high-capacity media.

A sequence of optical effects may be recorded on a recordable medium, and wherein a first part of the sequence may be read during a first part of the recording process to obtain the read signal. The write strategy may be optimized in the optimization process of the present invention and used in a second part of the recording process.

In the walking OPC method currently in use in DVD+R and future BD+R drives, the write-power is checked every +/−100 tracks. The apparatus according to the present invention may include a walking optimization type routine, however, where both write power and write strategies may be optimized from the inner to the outer diameter. In a walking optimization type routine according to the present invention, a sequence of optical effects, such as a number of tracks, are recorded. A part of the sequence, e.g. the last written track is read and the average transition shifts are determined and an optimization process is conducted on the basis of the part of the sequence, i.e. on the basis of the last track. The optimized write conditions are then used in the further recording process, until a new optimization is performed, e.g. after 100 tracks have been recorded (or any appropriate number of tracks). In this way an optimal write quality is ensured for the entire recording process.

The average transition shift may be determined as a function of the width of the region prior to a specific transition and/or the width of the following region. For example, the timing of a given leading edge may be determined as a function of width of the specific (or current) mark and the previous space length, and the timing of a given trailing edge may be determined as a function of the width of the specific (or current) mark and the next space. This may be represented in a 2D matrix, an L-matrix, for leading edges with the matrix elements being arranged as (current mark, previous space), and a 2D T-matrix for trailing edges with the matrix elements being arranged as (current mark, next space). It is an advantage to determine the timing of the leading and trailing edges in this manner, since it directly provides the systematic behavior of the various pattern combinations present on a disk, and thereby directly reveals a systematic error in the time positioning of the various pattern combinations. Such a matrix representation thus provides a simple and useful qualification system.

The one or more write parameters may include a power level and/or a level duration as well as a timing of a write pulse in the radiation beam, the timing being obtained in relation to a system clock. Processing means may evaluate the average transition shifts and optimize least one of the one or more write parameters in the write strategy in accordance with rules.

It is an advantage to be able to directly correlate a value of a transition shift for a given transition to a power level, a level duration or a timing of the write pulse, and by means of processing means optimize the write parameters according to rules. The rules may include relationships between a given transition shift, the value of the transition shift and a corresponding write parameter.

According to a second aspect of the present invention is provided an integrated circuit (IC) for controlling an optical recording apparatus, the IC being adapted to optimize one or more write parameters in a write strategy according to the average transition shifts of a specific type of leading and/or trailing edge of a measured read signal, the write strategy being optimized in a feed-forward optimization process.

The IC may be incorporated in an apparatus according to the first aspect of the present invention, or may be provided as a standalone IC (or chipset), which may be incorporated in an optical recording apparatus in order to include the optimization process of the present invention.

According to a third aspect of the present invention is provided computer readable code for controlling an optical recording apparatus, the apparatus being controlled to optimize one or more write parameters in a write strategy according to the average transition shifts of a specific type of leading and/or trailing edge of a measured read signal, the write strategy being optimized in a feed-forward optimization process.

The computer readable code may control an IC in order to be able to control a recording apparatus so as to include the functionality of the optimization process of the present invention.

According to a fourth aspect of the present invention is provided a method of optimizing a write strategy comprising one or more write parameters, the method comprising the steps of:

providing a measured read signal, the read signal comprising first sections reflected from first regions with first widths, and second sections reflected from second regions with second widths, wherein transitions from the first to the second regions are labeled leading edges and transitions from the second regions to the first regions are labeled trailing edges,

providing modulation bits corresponding to the read signal,

determining average transition shifts of leading and/or trailing edges by comparing a timing of the read signal and a timing of the modulation bits,

wherein at least one of the one or more write parameters in the write strategy is optimized in a feed-forward optimization process taking the average transition shifts into account.

The method may be implemented in an IC according to the second aspect and/or the computer code according to the third aspect may be adapted to perform the method steps according to the fourth aspect.

These and other aspects, features and/or advantages of the invention will be apparent from and elucidated with reference to the embodiments described hereinafter. Embodiments of the invention will be described, by way of example only, with reference to the drawings, in which

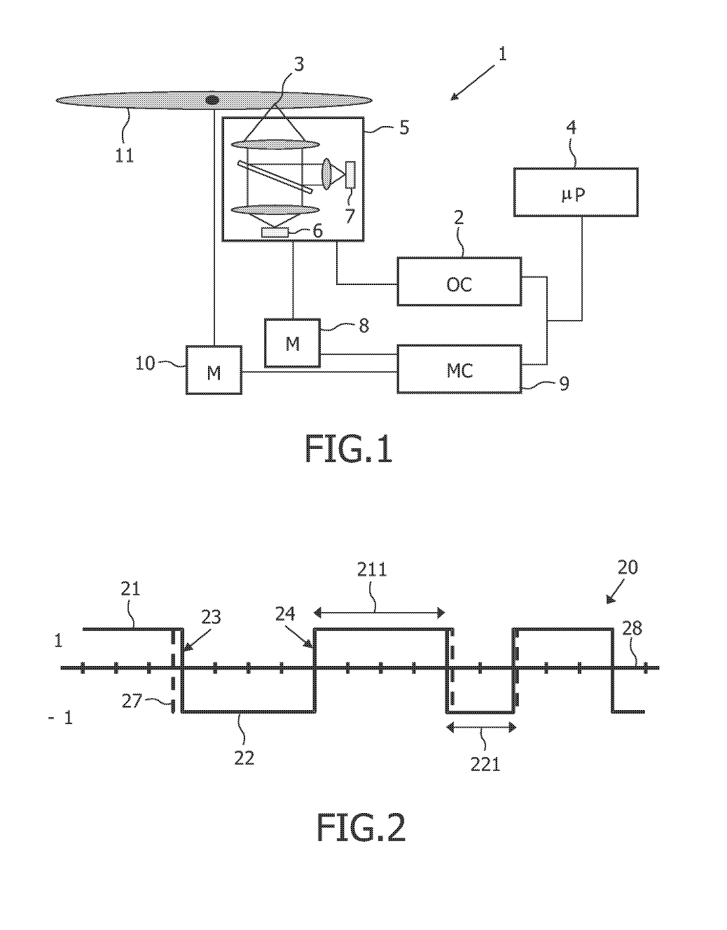

FIG. 1 schematically illustrates an optical recording apparatus capable of reading and/or writing information from and/or to an optical storage medium,

FIG. 2 schematically illustrates a series of channel bits from an optical signal,

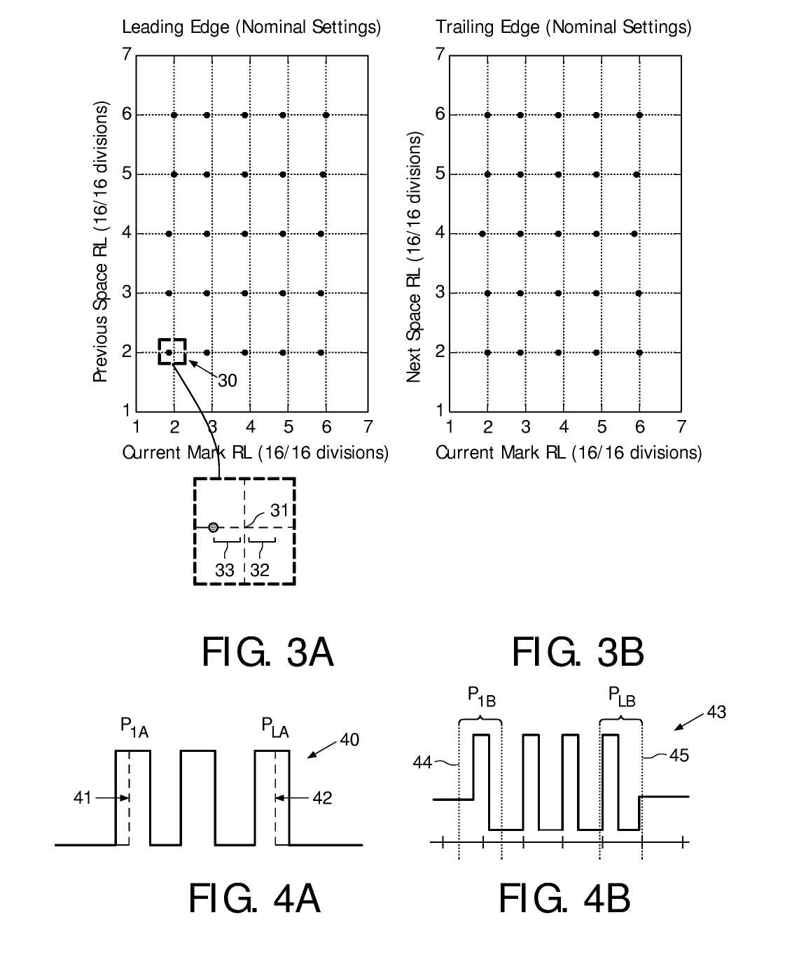

FIG. 3 shows matrix graphs for transitions from a mark runlength to a space runlength,

FIG. 4 shows a schematic drawing of mark write strategies,

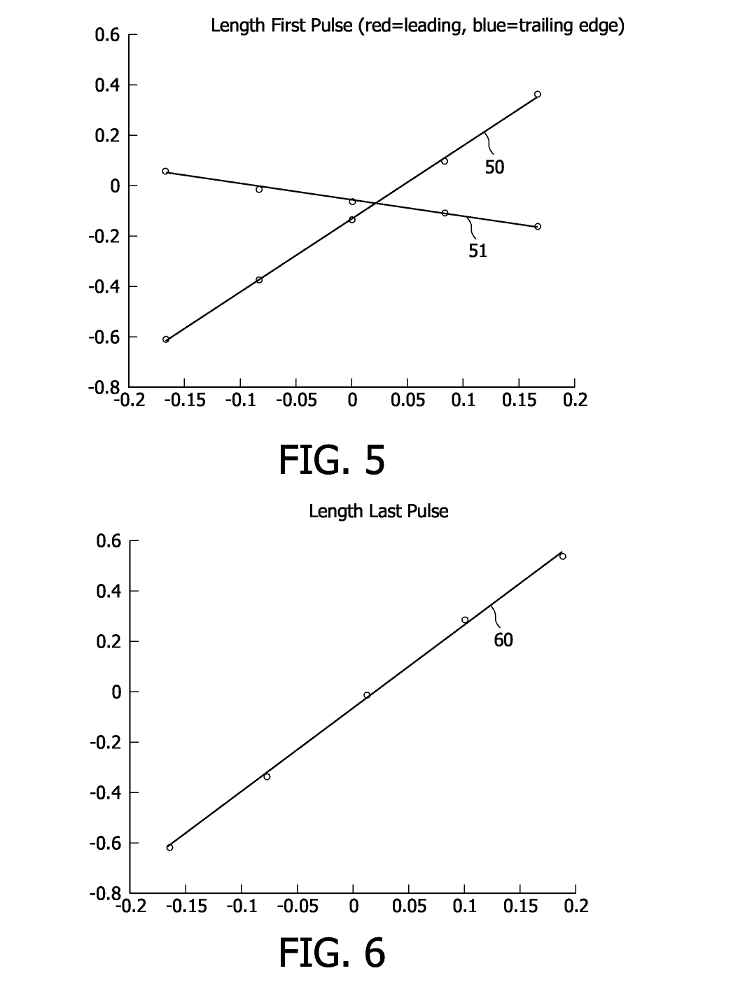

FIG. 5 illustrates edge position (transition shift) as a function of a first write parameter,

FIG. 6 illustrates edge position (transition shift) as a function of a second write parameter, and

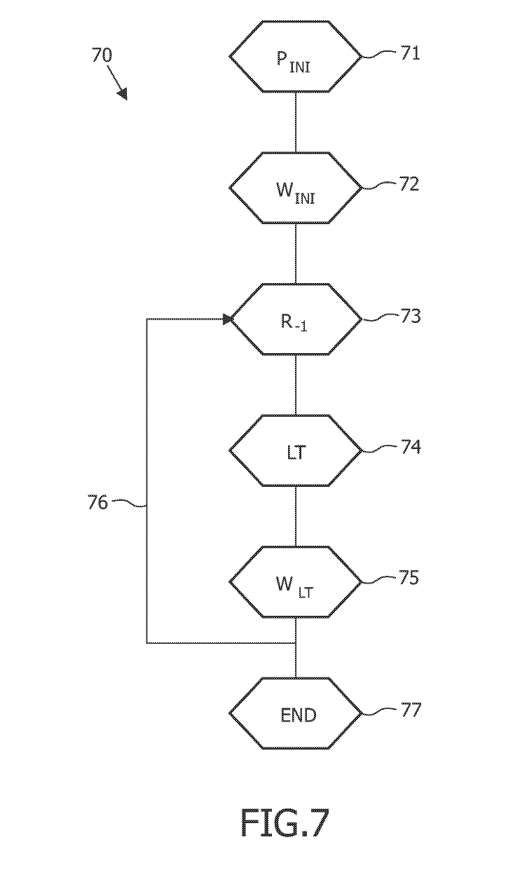

FIG. 7 illustrates a flow diagram of an embodiment of the present invention.

An optical storage apparatus 1 capable of reading and/or writing information from and/or to an optical storage medium is schematically illustrated in FIG. 1.

A real optical storage apparatus comprises a large number of elements with various functions, only a few are illustrated here. Motor means 8,10 are present for rotating the disk 11 and controlling the motion of an optical pickup unit 5, so that an optical spot 3 can be focused and positioned at a desired location on the disk. The optical pickup unit includes a laser 6 for emitting a laser beam which may be focused on the disk by means of a number of optical elements. The focused laser light may in a recording mode be sufficiently intense so that a physical change may be provided to the optical disk, i.e. optical effects are provided onto the disk. Alternatively, in a reading mode the laser power is insufficient to induce a physical change and the reflected laser light detected by a photodetector 7 for reading the optical effects on the disk.

In the present invention the read signal from the optical recording medium may be the signal as seen by the photodetector 7, the signal may either by a dedicated unit (not shown) or by processing means 4 be transformed into a form which is suitable for further processing.

The control of the storage apparatus may be done either by hardware implementation, such as illustrated by the motor control 9 and optics control 2. In addition, also microprocessor control means 4 is present. The microprocessor control means (e.g. integrated circuit (IC) means) may contain both hardwired processing means and software processing means, so that e.g. a user, such as by means of a high-level control software, may influence the operation of the apparatus. Examples of high-level control settings include control of the pulse shape in a write strategy of the emitted laser power in recording mode.

Optical effects are aligned along a track spiraling from the center and outwards. Data is stored in effects and spaces between the effects of different runlengths, i.e. different widths (lengths) of the effects and the spaces. Important for the optimal performance of a given disk is that all marks and spaces are integer step like. When the lengths of the marks and spaces are not exactly a multiple of the channel bit length, this will be seen as deviations from the optimal situation and will result in a deteriorated bit detection performance.

FIG. 2 illustrates a series of channel bits from an optical signal. The series of channel bits 20 comprising first sections 21 corresponding to light reflected from first regions with first widths 211, being spaces or high reflectivity regions, and second sections 22 corresponding to light reflected from second regions with second widths 221, being marks or low intensity regions. The transitions from the first to the second regions are labeled leading edges 23, and transitions from the second regions to the first regions are labeled trailing edges 24.

On a real disk, the transitions from a high reflectivity (space) to low reflectivity (mark) are not always on the right position. Some are too much to the left (early in time=negative per definition) and some too much to the right (too late=positive). This is illustrated by the dotted lines 27 which indicate the measured edge position. In the figure a time axis 28 is illustrated as a horizontal axis, the time axis being discretized with so-called 1T (=1 channel bit) resolution. For an ideal signal, the transitions should lie on a 1T mark.

Embodiments of implementations of the present invention are described in the following. Thus embodiments of an optical recording apparatus with optimized write strategy control.

Edge shifts that are systematic (with a predictable behavior) can be compensated in a write strategy. The marks have a leading and trailing edge, which can be shifted. These edge shifts are of course a function of the (current) mark length (I_{cm}). Furthermore, in the case of a leading edge, there might be influence of the previous space length (Iₚₛ), for example due to the thermal history, this effect can be seen as Inter Symbol Interference (ISI) in the write-channel. For the trailing edge, there might be influence of the next space (Iₙₛ). The shifts may be written as a 2D matrix, with matrix elements L(cm,ps) for the leading edges and matrix elements T(cm,ns) for the trailing edges. The spaces need not be dealt with, because they automatically fall in-between the written marks.

The average transition shifts of the various combination of marks and previous/next adjacent spaces may be measured on an optical disk. An example of a matrix representation of the transition shifts is given in FIG. 3 for measurements on a write-once disc with a nominal write strategy.

In FIG. 3, all leading (FIG. 3A) and trailing (FIG. 3B) edge shifts are shown, and for every combination of current mark (x-axis) and prev/next space (y-axis) a dot 30 is drawn. The dot is found exactly on the cross-point 31 when there is no shift, and on the right 32 of it when there is a positive shift (too late) and on the left 33 of this cross-point when there is a negative shift (too early). The matrix graphs as illustrated in FIG. 3 is obtained from the last written track and the shifts of the leading and trailing edges represents the average shifts of the transition as measured on the last written track. Based on this measurement, one can compensate the write strategy. How this compensation has to be done may depend on the linearity/non-linearity of the writing process.

In a walking optimization method the write strategy is normally optimized is in a reserved zone on the disk. Next, the system can start writing. After writing e.g. 100 tracks, the system jumps one track back, and analyses the quality of the last written track. Because the disk is not perfectly homogeneous, the system is heating up etc., it might be needed to adapt the write strategy slightly to improve write performance. This process is done every 100 tracks, and in this way a disk can be written full. Normally one can only adapt the write power, because only one parameter is measured when reading the last written track, however by providing the transition shifts of all leading and trailing edges, it is possible to adapt a lot of parameters in the write strategy.

In order to obtain further insight into the application of the present invention, the write strategy is changed a bit, and effects in the LT-matrixes are discussed.

Optimization of write strategies on write-once disks is first discussed. In order to compensate a leading/trailing edge that is x/16 of a T too early or too late it should be determined how much the write strategy should be changed to move a leading or trailing edge with an amount x/T on the disk. To investigate this the write strategy of the I4's are changed. The write pulse 40 of an I4 is illustrated in FIG. 4A.

When the first pulse, P_{1A}, of the I4 mark strategy is changed, the Leading edge 50 of the I4 is moving, as is illustrated in FIG. 5. In the figure is the edge position (transition shift) versus the start position (relative to nominal) of the first pulse is illustrated for a situation where the starting position of the first pulse is moved 41. It may be seen that for a pulse start of 1/16th T later results in a shift of the edge on the disc with about 3/16th T. In the case the laser driver has enough resolution (a resolution of 1/40th T or better may be achievable), it is possible to exactly put the leading edge on the right position. When the first pulse starts later, and stops at the same moment, less power is inserted into the write-once system. This may result in a trailing edge that moves to the left (earlier in time). This is confirmed by measurements as shown in FIG. 5 by the line marked 51. But due to the small slope of this process, the leading edge can be modified almost independent of the trailing edge. (Furthermore, in a situation where the edge shifts between every optimization step are small, also the cross talk is very small). A nice linear dependence of the edge position on the length of the first pulse is found. The small deviations from the linearity may be taken as a measure of the accuracy of which the edge shifts can be determined.

Also the length of the last pulse, P_{LA}, of the I4 mark strategy may be changed 42. In FIG. 6 is illustrated the trailing edge shift 60 of the I4 mark versus the length of the last pulse. In this case, no cross talk to the leading edge before is observed (this stack does not suffer from post-heat).

Examples of a write-once system were provided above, however, also rewritable (RE) write strategies can be adapted in a walking optimization type fashion, so that the write strategy can adapt while writing in a constant angular velocity mode. Compensation of the write strategy on RE may be obtained in the following way (an example of a RE-write strategy is provided in FIG. 4B). By moving the first pulse, P_{1B}, one can compensate the leading edge in a 1-to-1 fashion. The trailing edge can be shifted, by moving the last write-pulse, P_{LB}, and the start of the erase pulse level, also with a 1-to-1 ratio. A flow diagram 70 illustrating an embodiment of the present invention is provided in FIG. 7. In a first step 71 initial write parameters (Pᵢₙᵢ) are provided, e.g. by performing tests in a reserved zone on the disk. Having these parameters, the system can start writing data (Wᵢₙᵢ) on the disk, as illustrated in a second step 72. The initial parameters may be determined from the LT method, i.e. from a determination of the transition shifts.

After writing a number of tracks, e.g. 100 tracks, the system jumps one track back (R₋₁) in a next step 73 and reads this last track. The quality of the last written track is analyzed by means of the LT method 74. The write strategy is optimized 75 and the next block of tracks (again e.g. 100) is written by using the optimized write parameters (W_{LT}). After 76 writing a block of tracks using the optimized write parameters, the system once again reads the last written track 73 and continues with the optimization procedure until all data has been provided to the disk 77.

Although the present invention has been described in connection with preferred embodiments, it is not intended to be limited to the specific form set forth herein. Rather, the scope of the present invention is limited only by the accompanying claims.

In this section, certain specific details of the disclosed embodiment such as specific processing steps, data representations, specific parameters etc., are set forth for purposes of explanation rather than limitation, so as to provide a clear and thorough understanding of the present invention. However, it should be understood readily by those skilled in this art, that the present invention may be practiced in other embodiments which do not conform exactly to the details set forth herein, without departing significantly from the spirit and scope of this disclosure. Further, in this context, and for the purposes of brevity and clarity, detailed descriptions of well-known apparatus, circuits and methodology have been omitted so as to avoid unnecessary detail and possible confusion.

Reference signs are included in the claims, however the inclusion of the reference signs is only for clarity reasons and should not be construed as limiting the scope of the claims.

1. Optical recording apparatus (1) with optimized write strategy control, the apparatus comprising:
a radiation source (6) for emitting a radiation beam so as to record optical effects on a recordable medium (11), the radiation beam being emitted in accordance with a write strategy (40,43) including one or more write parameters,
a read unit (7) for reading the recorded effects so as to provide a read signal, the read signal (20) comprising first sections (21) reflected from first regions with first widths (211), and second sections (22) reflected from second regions with second widths (221), wherein transitions from the first to the second regions are labeled leading edges (23) and transitions from the second regions to the first regions are labeled trailing edges (24),
wherein average transition shifts of leading and/or trailing edges are determined in the read signal, and wherein at least one of the one or more write parameters in the write strategy (40,43) is optimized in a feed-forward optimization process taking the average transition shifts (30) into account.

2. Apparatus according to claim 1, wherein a sequence of optical effects is recorded on a recordable medium, and wherein a first part of the sequence is read during a first part of the recording process and the read signal is obtained from the first part of the sequence, and wherein the write strategy is optimized in the optimization process, the optimized write strategy being used in a second part of the recording process.

3. Apparatus according to claim 1, wherein the average transition shift is determined as a function of the width of the region prior to a specific transition and/or the width of the following region.

4. Apparatus according to claim 1, wherein the one or more write parameters include a power level and/or a level duration.

5. Apparatus according to claim 1, wherein the one or more write parameters include a timing of a write pulse in the radiation beam, the timing being obtained in relation to a system clock.

6. Apparatus according to claim 1, further comprising processing means for evaluating the average transition shifts and optimize least one of the one or more write parameters in the write strategy in accordance with rules.

7. Integrated circuit (IC) for controlling an optical recording apparatus, the IC being adapted to optimize one or more write parameters in a write strategy according to the average transition shifts of specific types of leading and/or trailing edges of a measured read signal, the write strategy being optimized in a feed-forward optimization process.

8. Computer readable code for controlling an optical recording apparatus, the apparatus being controlled to optimize one or more write parameters in a write strategy according to the average transition shifts of specific types of leading and/or trailing edges of a measured read signal, the write strategy being optimized in a feed-forward optimization process.

9. Method of optimizing a write strategy comprising one or more write parameters, the method comprising the steps of:
providing a measured read signal (20), the read signal comprising first sections (21) reflected from first regions with first widths (211), and second sections (22) reflected from second regions with second widths (221), wherein transitions from the first to the second regions are labeled leading edges (23) and transitions from the second regions to the first regions are labeled trailing edges (24),
providing modulation bits corresponding to the read signal,
determining average transition shifts (30) of leading and/or trailing edges by comparing a timing of the read signal and a timing of the modulation bits,
wherein at least one of the one or more write parameters in the write strategy (40,43) is optimized in a feed-forward optimization process taking the average transition shifts into account.
